(19) United States
(12) Patent Application Publication
(10) Pub. No.: US 2005/0118357 A1
(43) Pub. Date: Jun. 2, 2005

(54) Instrument panel comprising a layer of a thermoplastic copolyester elastomer composition

(76) Inventors: Ronald F.M. Lange, Ludwigshafen (DE); Gerhard Rutgers, Sittard (NL)

Correspondence Address: MAYER, BROWN, ROWE & MAW LLP, 1909 K STREET, N.W., WASHINGTON, DC, 20006, US

(21) Appl. No.: 10/498,871

(22) PCT Filed: Dec. 17, 2002
(86) PCT No.: PCT/NL02/00838

(30) Foreign Application Priority Data
Dec. 18, 2001 (EP) 012052205

(51) Int. Cl. B32B 27/06; B32B 27/36

(52) U.S. Cl. 428/31; 428/480

(57) ABSTRACT

An instrument panel comprising a layer of a thermoplastic copolyester elastomer composition, that contains as major component at least one copolyether ester consisting essentially of polyester hard segments that are built up from repeating units derived from at least one alkylene diol and at least one aromatic dicarboxylic acid or an ester thereof and polyether soft segments derived from a poly(propylene oxide)diol. The instrument panel according to the invention has a skin layer of high homogeneity, very good performance at low temperature and high resistance to long-term heat ageing, and shows good adhesion to other materials.

The invention relates to an instrument panel comprising a layer of a thermoplastic copolyester elastomer composition.

Such an instrument panel is known from a publication in Automotive Engineering, May 1997, pages 4345.

Instrument panels, like automotive instrument panels, also referred to as dashboards, generally are composite articles comprising structural elements, foam layers and a skin layer or cover layer. The skin layer may be the actual top layer or be coated with e.g. a paint layer. Various thermoplastic materials are being used as such a layer. Established materials are polyvinyl chloride (PVC) compositions, including PVC/ABS blends, because of their low cost and favourable processing characteristics. The use of PVC compositions, however, is facing increasing resistance because of environmental reasons, relating to the high chlorine content, and because of performance problems, like fogging phenomena of plasticizers contained in these compositions and brittleness at low temperatures. Several alternative materials have been identified, like thermoplastic polyurethane (TPU) compositions (for example in EP 1033379 A2), thermoplastic vulcanisates based on polyolefins (TPV; e.g. WO 9821273 A2), compositions based on copolymers of olefins and polar and/or functional monomers (e.g. WO 0063286 A1), or elastomer compositions based on block copolymers of conjugated dienes and styrenes (e.g. WO 9932558 A1). None of these materials appears to provide the desired combination of properties, but show either disadvantageously high cost, insufficient cold impact resistance, low wear and scratch resistance, insufficient chemical resistance, poor long term heat-ageing, or a combination of these. Low-temperature performance is becoming more and more decisive in material selection, considering more stringent standards for e.g. head-impact and air-bag door deployment. Recent test standards require controlled opening of an air bag door at −35° C. without liberating small particles or splintering. This latter aspect is even more important if an air bag door is desired that forms an integral part of the panel and is virtually invisible at the outside. In the cited article in Automotive Engineering, May 1997, thermoplastic copolyester elastomer compositions, in general, are indicated to have high potential as alternative material as a skin layer in instrument panels.

A drawback of the known instrument panel comprising a layer of a thermoplastic copolyester elastomer composition is that either the stringent low-temperature standards for impact and air-bag door deployment standards are not met, or if so, some high-temperature durability is sacrificed.

The object of the present invention is therefore to provide an instrument panel that does not show said performance problems.

This object is achieved according to the invention with an instrument panel comprising a layer of a thermoplastic copolyester elastomer composition that contains as major component at least one copolyether ester consisting essentially of polyester hard segments that are built up from repeating units derived from at least one alkylene diol and at least one aromatic dicarboxylic acid or an ester-forming derivative thereof and polyether soft segments derived from a poly(propylene oxide)diol.

The instrument panel comprising a layer of a thermoplastic copolyester elastomer composition according to the invention that shows very good performance at low temperatures, even below −35° C., and retains physical properties when subjected to long term, high temperature (e.g. 120° C.) ageing tests.

Another advantage of the instrument panel according to the invention is that it can comprise both a flip-top or an invisible, integral air bag door. Such air bag doors pass deployment tests at −35° C. with controlled opening and without liberating small particles or splintering. Still another advantage of the instrument panel according to the invention is that it shows no fogging when subjected to long term, high temperatures (e.g. 120° C.), e.g. when a car is exposed to the sun. Another advantage of the instrument panel according to the invention is that the layer of thermoplastic copolyester elastomer composition shows good adhesion to various other materials, including coating or paint layers applied to it and to polyurethane foams on which it functions as a (skin) layer, without the need of adhesion promotors.

In a preferred embodiment of the invention, the layer of a thermoplastic copolyester elastomer composition is a skin layer of the instrument panel. The thermoplastic copolyester elastomer composition can be mass coloured in any desired colour and shade, has high heat- and colour-stability, and good wear resistance. Therefore, the presence of a coating layer, which would increase the cost-price of the panel, is not necessary.

In another preferred embodiment of the invention, the instrument panel is an automotive instrument panel provided with virtually invisible and integral air bag doors. The excellent low-temperature performance of the thermoplastic copolyester elastomer composition forming a layer of the instrument panel enables such aesthetic dashboard design, without sacrificing performance at elevated temperature. Such an instrument panel with integrated air bag doors passes the most stringent air bag deployment test at −35° C. with controlled opening and without liberating small particles or splintering.

A thermoplastic copolyester elastomer composition is understood to mean a composition that contains as major component at least one copolyester elastomer. Major component is understood to mean that the at least one copolyester elastomer forms a continuous phase or matrix of the composition.

A thermoplastic copolyester elastomer is also referred to as segmented copolyester or block copolyester. Such a segmented copolyester is understood to be a segmented copolymer containing hard polyester segments and soft segments of a flexible polymer; that is a substantially amorphous polymer with a glass-transition temperature (T_{g}) of below 0° C. Examples of soft segments are segments derived from aliphatic polyesters or polycarbonates, or aliphatic polyethers. This last segmented copolyester is also referred to as copolyether ester.

The copolyether ester in the copolyester elastomer composition that is forms a layer in the instrument panel according to the invention has polyether soft segments derived from a poly(propylene oxide)diol. Diol in poly(propylene oxide)diol is understood to mean that the poly(propylene oxide) has essentially hydroxyl groups as end groups; that is has a hydroxyl functionality of about 1.7-2.3. A lower functionality would hamper synthesis of a copolyether ester of sufficiently high molar mass; a higher functionality would undesirably increase chain branching or even induce crosslinking of the copolyether ester. The hydroxyl functionality is therefore preferably 1.8-2.2, more preferably 1.9-2.1, and even more preferably about 2. Within the context of the present application a poly(propylene oxide) is understood to indicate a copolymer of propylene oxide and optionally another alkylene oxide with 1-6 carbon atoms, with propylene oxide constituting at least 50 mole %, preferably at least 60 mole % of the copolymer. Suitable alkylene oxides are for example ethylene oxide, tetrahydrofuran or tetramethylene oxide, or neopentylene oxide. Preferably, tetramethylene oxide and/or neopentylene oxide are used as comonomers in a random copolymer with propylene oxide. The advantage of such copolymers is a low T_{g}, resulting in good low temperature performance of a copolyether ester comprising these copolymers as soft segment.

In a preferred embodiment of the invention the copolyester elastomer composition contains a copolyether ester with polyether soft segments derived from an ethylene oxide-terminated poly(propylene oxide)diol. With an ethylene oxide-terminated poly(propylene oxide)diol is indicated a triblock copolymer with a poly(propylene oxide) as defined above as the central block, and two end blocks of poly(ethylene oxide). Advantages of such a polyether as soft block include its hydroxyl functionality and good reactivity and compatibility in the synthesis of polyether esters. The mass ratio of propylene oxide and ethylene oxide in the soft block may vary within a wide range, for example between 20:1 and 1:6, but is preferably between 10:1 and 1:1. Advantages of such a polyether segment include better properties of a polyether ester at elevated temperatures and easier processing behaviour, e.g. better release of a slush-moulded product. Without wishing to be bound to any theory, the inventors assume this may be related to better retention of crystallinity of the polyester hard segment in the copolyether ester.

Preferably, the T_{g} of the polyether segment is below −20° C., more preferably below −40, and most preferably below −50° C. The molar mass of the soft segments may vary within a wide range, but preferably the molar mass is chosen between 400 and 6000, more preferably between 500 and 4000, and most preferably between 750 and 3000 g/mol. Advantage thereof is improved performance at low temperatures with retention of properties at elevated temperature.

The at least one copolyether ester in the copolyester elastomer composition that forms a layer in the instrument panel according to the invention contains hard segments that are built up from repeating units derived from at least one alkylene diol and at least one aromatic dicarboxylic acid or an ester thereof. The alkylene diol contains generally 2-6 C-atoms, preferably 2-4 C-atoms. Examples thereof include ethylene glycol, propylene diol and butylene diol. Preferably, 1,4-butylene diol is used. Examples of suitable aromatic dicarboxylic acids include terephthalic acid, 2,6-naphthalenedicarboxylic acid, 4,4′-biphenyldicarboxylic acid or combinations of these. The advantage thereof is that the resulting polyester is generally semi-crystalline with a melting point of above 150, preferably above 175, and more preferably of above 190° C. The hard segments may optionally further contain a minor amount of units derived from other dicarboxylic acids, for example isophthalic acid, which generally lowers the melting point of the polyester. The amount of other dicarboxylic acids is preferably limited to not more than 10, more preferably not more than 5 mol %, so as to ensure that, among other things, the crystallization behaviour of the copolyether ester is not adversely affected. The hard segment is preferably built up from ethylene terephthalate, propylene terephthalate, and in particular from butylene terephthalate as repeating units. Advantages of these readily available units include favourable crystallisation behaviour and a high melting point, resulting in copolyether esters with good processing properties and excellent thermal and chemical resistance.

In other preferred embodiments of the invention, the hard segments in the polyether ester are built up from units derived from ethylene glycol, 4,4′-biphenyldicarboxylic acid, terephthalic acid and/or 2,6-naphthalenedicarboxylic acid, and optionally minor amounts of other diacids and/or diols. These copolyether esters show a high crystalline melting point, and fast crystallisation upon cooling from the melt.

The ratio of soft to hard segments in the copolyether ester in the composition that forms a layer in the instrument panel may vary within wide limits, but is preferably chosen such that a copolyether ester of relatively low hardness is obtained. Preferably, the hardness of the copolyether ester is below 46 Shore D, more preferably below 40 Shore D. A lower hardness of the copolyether ester generally results in improved low temperature performance and better soft feel, or soft touch, of the instrument panel according to the invention.

The copolyether ester can further contain a compound with two or more functional groups that can react with an acid- or hydroxyl-group, acting as chain extension or chain branching agent, respectively. Examples of suitable chain extension agents include carbonylbislactams, diisocyanates and bisepoxides. Suitable chain branching agents include e.g. trimellitic acid, trimellitic acid anhydride and trimethylol propane. The amount and type of chain extension or branching agent is chosen such that a block copolyester of desirable melt viscosity is obtained. In general, the amount of a chain branching agent will not be higher than 6.0 equivalents per 100 moles of dicarboxylic acids present in the copolyether ester.

Examples and preparation of copolyether esters are for example described in Handbook of Thermoplastics, ed. O. Olabishi, Chapter 17, Marcel Dekker Inc., New York 1997, ISBN 0-8247-9797-3, in Thermoplastic Elastomers, 2nd Ed, Chapter 8, Carl Hanser Verlag (1996), ISBN 1-56990-2054, in Encyclopedia of Polymer Science and Engineering, Vol. 12, Wiley & Sons, New York (1988), ISBN 0471-80944, p.75-117, and the references cited therein. mechanically reduced in size, for example by grinding at low temperature. Preferably, grinding, milling, or pulverizing of the composition is performed below the glass transition temperature or temperatures of the copolymers in the composition; that below −70 or even below −90° C., in order to obtain a powder of more regular form.

For slush moulding processing, the copolyester elastomer composition is normally in powder or micropellet form with particle size generally below 1200 μm. Particle size, i.e. particle diameter, is normally measured by sieving with standard mesh sizes. Particle size is primarily determined by the desired end use. For instance, if a thin smooth layer is desired, the particle size should be relatively small compared to the particle size used to make a thick layer or sheet. In the first case, powders having a particle size of less than 500 μm, preferably less than 400 μm, more preferably from 100-350 μm are used; whereas otherwise particle size of 500-1000 μm may give acceptable results.

Flow behaviour of the powdered copolyester elastomer composition can be improved by coating it with a fine powder, for example by dry blending with a mineral of particle size below 10 μm, such as alumina or silica or another inorganic oxide. The amount of such fine powder is generally between 0.1 and 10 mass % (based on total composition).

The invention will now be further elucidated with reference to the following examples.

### EXAMPLE 1

A copolyester elastomer composition containing as major component a copolyether ester consisting essentially of polyester hard segments built up from butylene terephthalate units and soft segments derived from an ethylene oxide-terminated poly(propylene oxide)diol of molar mass (Mₙ) of about 2300 g/mol and ratio propylene oxide/ethylene oxide of about 2/1, with a hardness of about 38 Shore D, and further containing an effective heat- and UV-stabilisation system and carbon black, and with a relative solution viscosity (RSV, as measured on a 1 mass % solution of copolymer in m-cresol at 25° C.) of 2.8, was cryogenically grinded using liquid nitrogen and then sieved into a powder with particle size of about 100-350 μm.

The powdered copolyester elastomer composition was fed into a preheated mould in the shape of a dashboard and distributed along the surface in about 30 sec., after which the mould was further heated at about 245° C. in an oven; followed by immersing the mould in water to cool mould and article. A slush-moulded sheet of about 1 mm thickness could be removed from the mould without problems, and without visible deformation of the sheet. This sheet can be suitably used as a dashboard skin in an automotive instrument panel.

Comparative Experiment A

A heat- and UV-stabilized black copolyester elastomer composition containing as major component a copolyether ester consisting essentially of polyester hard segments built up from butylene terephthalate units and soft segments derived from a poly(tetramethylene oxide)diol of Mₙ of about 2000 g/mol, with Shore D hardness of about 40 and RSV of 3.45, was cryogenically grinded and subsequently sieved into a powder with particle size of about 100-350 μm.

This powdered copolyester elastomer composition, which is of different chemical composition than a copolyether ester as used in the process according to the invention, was analogously to Example 1 fed into the preheated mould and distributed along the surface in about 30 sec., after which the mould was further heated at about 245° C. in an oven; followed by immersing the mould in water to cool mould and article. The moulded sheet of about 1 mm thickness could only be removed from the mould with excessive force, thereby irreversibly deforming or even damaging the sheet; making it unsuitable for further use.

1. Instrument panel comprising a layer of a thermoplastic copolyester elastomer composition, wherein the thermoplastic copolyester elastomer composition contains at least one copolyether ester which forms a continuous phase and consisting essentially of polyester hard segments that are built up from repeating units derived from at least one alkylene diol and at least one aromatic dicarboxylic acid or an ester-forming derivative thereof and polyether soft segments derived from a poly(propylene oxide)diol.

2. Instrument panel according to claim 1, wherein the layer of a thermoplastic copolyester elastomer composition is a skin layer.

3. Instrument panel according to claim 1, wherein the panel is an automotive instrument panel with an invisible and integral air bag door.

4. Instrument panel according to claim 1, wherein the polyether soft segments have been derived from an ethylene oxide-terminated poly(propylene oxide)diol.

5. Instrument panel according to claim 4, wherein the ethylene oxide-terminated poly(propylene oxide)diol contains propylene oxide and ethylene oxide in a mass ratio of between 10 and 1.

6. Instrument panel according to claim 1, wherein the polyester hard segments are built up from butylene terephthalate units.

7. Instrument panel according to claim 1, wherein the copolyester elastomer composition has a hardness of below 46 Shore D.

8. Instrument panel according to claim 1, wherein the layer has been made by slush moulding of a thermoplastic copolyester elastomer composition.
